(19) United States
(12) Patent Application Publication
(10) Pub. No.: US 2012/0234296 A1
(43) Pub. Date: Sep. 20, 2012

(54) Pressure pipe fitting for a common-rail injection system

(75) Inventors: Christian Graspeuntner, Hallein (AT); Gerhard Unterberger, Hof (AT)

(73) Assignee: ROBERT BOSCH GMBH, Stuttgart-Feuerbach (DE)

(21) Appl. No.: 13/511,187

(22) PCT Filed: Nov. 22, 2010
(86) PCT No.: PCT/AT2010/000456

§ 371 Date: May 22, 2012

(30) Foreign Application Priority Data
Nov. 23, 2009 (AT) A 1854/2009

(51) Int. Cl. F02M 55/02; F16L 7/00; F02M 51/00

(52) U.S. Cl. 123/469; 285/123.1

(57) ABSTRACT

A pressure pipe fitting for feeding high-pressure fuel to, and discharging fuel from, an injector of a common-rail injection system of an internal combustion engine includes at least one inner pipe and an outer pipe coaxially arranged with the inner pipe, with an annular space formed between the outer and inner pipes, and an intermediate piece arranged in the annular space for coaxially positioning the inner pipe and the outer pipe. The inner pipe preferably has conical seat surface on its end face. A threaded connection is provided to position the intermediate piece at a defined axial distance from the seat surface on the inner pipe. The inner pipe comprises a stop acting in the axial direction and cooperating with a counter-stop of the intermediate piece.

The invention relates to a pressure pipe fitting for feeding high-pressure fuel to, and discharging fuel from, an injector of a common-rail injection system of an internal combustion engine, including at least one inner pipe and an outer pipe arranged coaxially with the inner pipe, and an intermediate piece, which is arranged in the annular space formed between the outer pipe and the inner pipe, for coaxially positioning the inner pipe and the outer pipe, wherein the inner pipe has a preferably conical seat surface on its end face, and a threaded connection is provided to position the intermediate piece at a defined axial distance from the seat surface on the inner pipe.

The invention further relates to a common-rail injection system of an internal combustion engine, including a plurality of injectors for injecting fuel into the combustion chamber of the internal combustion engine, and fuel lines for feeding high-pressure fuel to, and discharging fuel from, the injectors, wherein the high-pressure lines are each connected to the injectors by the aid of a pressure pipe fitting.

Injectors in a modular common-rail system are characterized in that a portion of the storage volume available in the system is provided in the injector itself. Thus, the structural dimension of the injector is increased, which has to be taken into account when arranging the components within the cylinder head cover. It has, in particular, turned out to be suitable in especially large injectors to realize the connection of the high-pressure feed line and the discharge of the occurring control and leakage quantity by the aid of a laterally connected, so-called pressure pipe fitting. The latter has to comprise several coaxial line sections in order to ensure both the supply of fuel and the discharge of control quantity within a component.

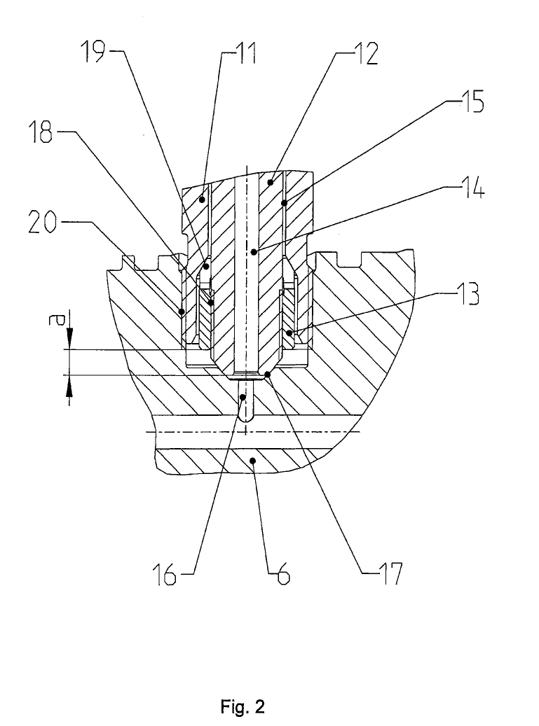

The coaxial parts in this case are formed by an outer pipe and an inner pipe, wherein an intermediate piece serves the precise coaxial positioning of the inner and the outer pipe. At the same time, the axial positioning of the intermediate piece is decisive, because the distance of the intermediate piece from the seat surface, which is formed on the inner pipe on the end face thereof, determines the abutment of the seat surface on the injector, and hence its tightness, and therefore has to be accordingly adjusted precisely and safely held in the adjusted position (cf. also the description of FIG. 2 further below). The connection design known from the prior art involves the drawback of the cumbersome adjustment of the cited distance and the required securing of the adjusted distance in order to prevent a change in the adjusted distance during handling.

The present invention aims to provide an improved design of a pressure pipe fitting, by which the above-mentioned drawbacks will be avoided.

To solve this object, the configuration according to the invention in a pressure pipe fitting of the initially defined kind essentially consists in that the inner pipe comprises a stop acting in the axial direction, which cooperates with a counter-stop of the intermediate piece. By the aid of said stop, the distance of the intermediate piece from the seat surface can be precisely and safely adjusted while, at the same time, implementing a thread lock in the threaded connection of the intermediate piece with the inner pipe. Also the mounting process will thereby be strongly simplified in terms of both expenditure and time.

The stop is preferably formed by a step provided on the outer periphery of the inner pipe between a first region of the inner pipe, adjacent to the first seat surface of the inner pipe, and a second region, disposed at a larger axial distance from the seat surface than the first region and having a larger diameter than the first region.

A thread lock-favouring configuration will result if the step has a generatrix that is relatively inclined to the pipe axis.

A further development in which the threaded connection of the inner pipe with the intermediate piece is provided in the second region will, moreover, be advantageous.

The application of the seat surface of the inner pipe against the respective connection on the injector is preferably realized in that the intermediate piece comprises a stop that cooperates with the inner periphery of the outer pipe and which, in a preferred manner, is formed by a plurality of tongues distributed about the periphery and capable of being bent, in particular being bent inwardly. In this context, it is advantageously provided that the outer pipe comprises a connecting means for fixing the pressure pipe fitting to a connection site of the injector, said connecting means being preferably formed by a thread.

Further advantages of the invention will be apparent from the subsequent description of the Figures.

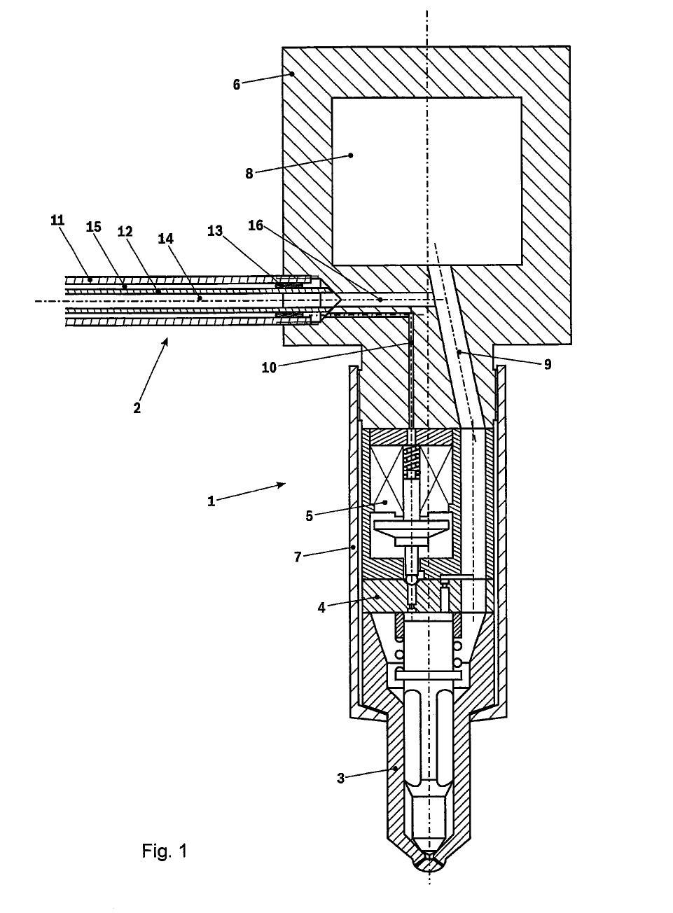

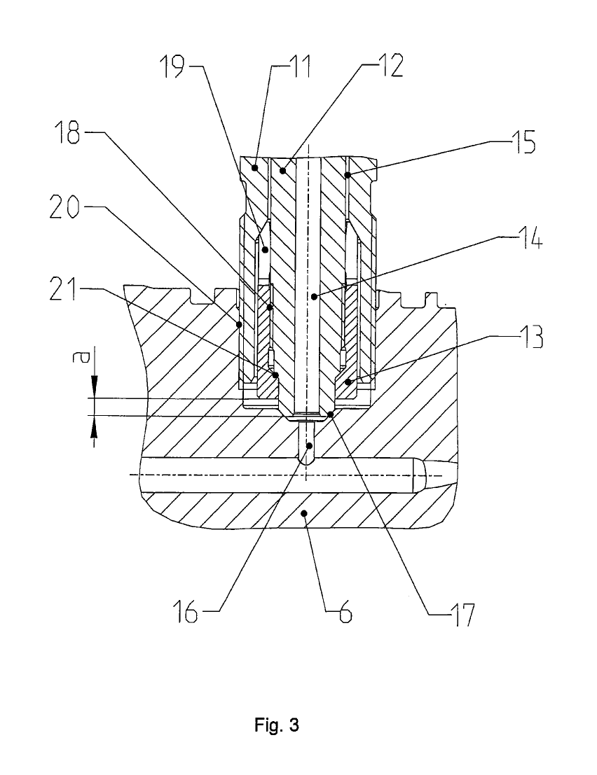

In the following, the invention will be explained in more detail by way of an exemplary embodiment schematically illustrated in the drawing. Therein, FIG. 1 schematically depicts the structure of a modular common-rail injector; FIG. 2 illustrates the connection of the pressure pipe fitting in the injector in a detailed view according to the prior art; and FIG. 3 illustrates the connection according to the present invention.

FIG. 1 depicts a modular common-rail injector 1 with a laterally connected pressure pipe fitting 2. The injector 1 comprises an injection nozzle 3, a throttle plate 4, a magnetic valve 5 and a holder body 6, which are held together by a nozzle clamping nut 7. Within the holder body 6 a high-pressure storage 8 is formed, from which fuel is fed to the functional components and the nozzle 3 via a high-pressure bore 9. The control quantity required for the hydraulic operation of the nozzle 3 is returned into the holder body 6 via the magnetic valve 5, and from there flows outwards in the low-pressure bore 10. The pressure pipe fitting 2 is composed of several parts. It is comprised of an outer pipe 11, an inner pipe 12, and an intermediate piece 13. The high-pressure intake 14 is formed in the inner pipe 12. There the fuel, which is under high pressure, flows into the injector, where it is conducted in the high-pressure intake bore 16 to the high-pressure bore 9. The control and leakage quantity from the low-pressure bore 10 occurring in the injector is conducted out of the cylinder head in the low-pressure annular space 15 between the inner pipe 12 and the outer pipe 11, and is fed back into the fuel tank. The coaxial positioning of the inner pipe 12 and the outer pipe 11 is effected by the aid of the intermediate piece 13.

FIG. 2 is a detailed view of the connection of the pressure pipe fitting 2 within the injector 1. The pressure pipe fitting 2 in this case is configured according to the prior art. The intermediate piece 13 is fastened to the inner pipe 12 by means of a thread 18, wherein the intermediate piece 13 is screwed onto the inner pipe 12 until a defined measure “a” is reached. After this, the component comprised of the inner pipe 12 and the intermediate piece 13 is loosely inserted into the outer pipe 11. The outer pipe 11 is then screwed into the holder body 6 by means of a thread 20. This causes a positive engagement between the outer pipe 11 and several tongues 19, which are attached to the intermediate piece 13. The tongues 19 are bent inwardly, thus positioning the inner pipe 12 coaxially with the outer pipe 11. At the same time, an axial force component is applied on the intermediate piece 13 to cause the inner pipe 12, which is screwed with the intermediate piece 13, to be pressed against the holder body 6, thus creating a high-pressure-tight connection on the seat 17. The drawback of that connection design resides in the complex adjustment of the measure “a” and the necessary thread lock in the thread 18 to prevent a change in the measure “a” during handling.

FIG. 3 illustrates the connection according to the present invention. In the configuration according to the invention, the inner pipe 12 comprises an additional step 21, which constitutes a stop when screwing the intermediate piece 13 onto the thread 18. This step 21 serves to adjust the measure “a” while, at the same time, implementing a thread lock in the thread 18. The mounting process will thereby also be strongly simplified in terms of both expenditure and time.

1. A pressure pipe fitting for feeding high-pressure fuel to, and discharging fuel from, an injector of a common-rail injection system of an internal combustion engine, including at least one inner pipe and an outer pipe arranged coaxially with the inner pipe, and an intermediate piece, which is arranged in the annular space formed between the outer pipe and the inner pipe, for coaxially positioning the inner pipe and the outer pipe, wherein the inner pipe optionally has a conical seat surface on its end face, and a threaded connection is provided to position the intermediate piece at a defined axial distance from the seat surface on the inner pipe, characterized in that the inner pipe (12) comprises a stop (21) acting in the axial direction and cooperating with a counter-stop of the intermediate piece (13).

2. A pressure pipe fitting according to claim 1, characterized in that the stop (21) is formed by a step provided on the outer periphery of the inner pipe (12) between a first region of the inner pipe (12), adjacent to the first seat surface of the inner pipe, and a second region, disposed at a larger axial distance from the seat surface than the first region and having a larger diameter than the first region.

3. A pressure pipe fitting according to claim 2, characterized in that the step has a generatrix that is relatively inclined to the pipe axis.

4. A pressure pipe fitting according to claim 2, characterized in that the threaded connection of the inner pipe (12) with the intermediate piece (13) is provided in the second region.

5. A pressure pipe fitting according to claim 1, characterized in that the outer pipe has an inner periphery and the surface of the intermediate piece comprises a stop that cooperates with the inner periphery of the outer pipe.

6. A pressure pipe fitting according to claim 1, characterized in that the outer pipe comprises a connecting means for fixing the pressure pipe fitting to a connection site of the injector.

7. A pressure pipe fitting according to claim 6, characterized in that the connecting means is formed by a thread.

8. A common-rail injection system of an internal combustion engine, including a plurality of injectors for injecting fuel into the combustion chamber of the internal combustion engine, and fuel lines for feeding high-pressure fuel to, and discharging fuel from, the injectors, characterized in that the high-pressure lines are each connected to the injectors by the aid of a pressure pipe fitting according to claim 1.

9. A common-rail injection system according to claim 8, characterized in that the injection system is configured as a modular injection system including injectors (1) each comprising its own high-pressure storage (8).

10. A common-rail injection system according to claim 8, characterized in that the injectors (1) each comprise a nozzle needle, which is disposed in a nozzle chamber fed by a high-pressure feed line formed by the inner pipe of the high-pressure fitting and, for controlling its opening and closing movements, can be pressurized in the axial direction by the pressure prevailing in a control chamber filled with fuel, wherein the pressure in the control chamber is controlled via a magnetic valve (5) opening or closing at least one inlet or outlet throttle for fuel, and the magnetic valve (5), for discharging the control quantify, communicates with a annular space (15) formed between the outer pipe (11) and the inner pipe (12) via a low-pressure bore.

11. A pressure pipe fitting according to claim 5, wherein the stop is formed by a plurality of bendable tongues distributed about the periphery of the intermediate piece.

12. A pressure pipe fitting according to claim 11, wherein the bendable tongues bend inwardly.
